(19) United States
(12) Patent Application Publication
(10) Pub. No.: US 2008/0288895 A1
(43) Pub. Date: Nov. 20, 2008

(54) Touch-Down Feed-Forward in 30D Touch Interaction

(75) Inventors: Gerard Hollemans, Eindhoven (NL); Huib V. Kleinhout, Waalre (NL); Jettie C. M. Hoonhout, Maastricht (NL); Sander B. F. Van de Wijdeven, Eindhoven (NL); Vincent P. Buil, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/570,925

(22) PCT Filed: Jun. 24, 2005
(86) PCT No.: PCT/IB2005/052103

§ 371 Date: Dec. 19, 2006

Related U.S. Application Data
(60) Provisional application No. 60/583,970, filed on Jun. 29, 2004.
(60) Provisional application No. 60/646,086, filed on Jan. 21, 2005.

(51) Int. Cl. G06F 3/033

(52) U.S. Cl. 715/863

(57) ABSTRACT

A 3-D display device in which zooming is controlled based on the distance that a user's finger is from the display screen, generates a virtual drop shadow of the user's finger at the detected X/Y position of the user's finger with respect to the display screen. The virtual drop shadow represents the center of the zooming of the display image. In addition the size and darkness of the drop shadow is changed relative to the distance that the user's finger is from the display screen.

### FIELD OF THE INVENTION

The subject invention relates to display devices, and more particularly to zooming an image being displayed on a 3-D touch interactive display device.

### DESCRIPTION OF THE RELATED ART

3-D virtual touch screen display devices are known which are able to measure where a user's finger is with respect to the screen in X, Y, and Z coordinates using, for example, capacitive sensing. For these types of display devices, the meanings of the X and Y coordinates are intuitively known as referring to the horizontal and vertical positions of the user's finger with respect to the display screen. However, a meaning needs to be given to the Z coordinate. Very often, this meaning is the zooming factor of an image being displayed on the screen of the display device.

When zooming in on what is being displayed, parts of the displayed image “drop off” the screen to make room for increasing the size of the remaining part of the displayed image. When a user's finger is at a significant distance from the display screen, it is difficult for the user to predict where he/she will end up, i.e., what part of the original image will be enlarged due to zooming. Small changes in the X and/or Y direction will make substantial differences in which part of the image will be enlarged, and correspondingly, which parts will consequently not be displayed.

Reductions in the effect of changes in the X and/or Y directions means that either the maximum zoom factor must be reduced resulting in an inadequate enlargement of the desired portion of the image, or the user must resort to panning/scrolling left, right, up and down to arrive at the desired enlarged portion of the original image. Both consequences work directly against the effect that is being pursued by using the Z coordinate to control the zooming, namely, to fit more on a display without having to resort to panning/scrolling.

An object of the invention is to provide the user with feedback on which part of an image being displayed will be zoomed in, and also an indication of the zoom factor.

This object is achieved in a 3-D display device capable of selectively zooming an image being displayed on said display device, said 2-D display device comprising means for detecting a distance that a finger of a user is from a display screen of the display device, said detecting means generating a detection signal when said distance is within a predetermined threshold distance; means for determining a position of said user's finger with respect to said display screen; means for displaying a virtual shadow on said display screen at said determined position in response to said detection signal, said virtual shadow having a predetermined initial size when said user's finger is at said predetermined threshold distance; means for initiating zooming of said image in response to said detection signal, said zooming being centered on said determined position, and an amount of said zooming being inversely dependent on said detected distance; and means for decreasing the size of the virtual shadow with respect to said detected distance.

The object is further achieved in a method for selectively zooming an image being displayed on said display device, said 2-D display device comprising the steps of detecting a distance that a finger of a user is from a display screen of the display device, and generating a detection signal when said distance is within a first predetermined threshold distance; determining a position of said user's finger with respect to said display screen; displaying a virtual drop shadow on said display screen at said determined position in response to said detection signal, said virtual drop shadow having a predetermined initial size when said user's finger is at said predetermined threshold distance; initiating zooming of said image in response to said detection signal, said zooming being centered on said determined position, and an amount of said zooming being inversely dependent on said detected distance; and decreasing the size of the virtual shadow with respect to said detected distance.

In the display device and method according to the invention, a virtual drop shadow of the user's finger is drawn on the display screen. The location of the drop shadow on the display screen indicates which part of the displayed image will be enlarged and the size and/or darkness of the drop shadow indicates the distance of the user's finger to the display screen, which thereupon corresponds to the degree of zooming still available to the user.

By indicating the degree of zoom still available in addition to the location the center of the zooming, the user gets improved feed-forward indicating what parts of the displayed image will drop off the screen when the user keeps zooming in the same manner. The user then will more easily see whether the center of the zooming is so far off target that, given the distance still to go to the screen, the target area will drop off the screen, thereby inviting the user to an early adapting of the trajectory of his/her finger towards the display screen.

Using this feedforward technique, the user may quickly learn how to adapt the trajectory early in the approach to the display screen thus minimizing the number of re-attempts to have the target area displayed when fully zoomed in.

With the above and additional objects and advantages in mind as will hereinafter appear, the invention will be described with reference to the accompanying drawings, in which:

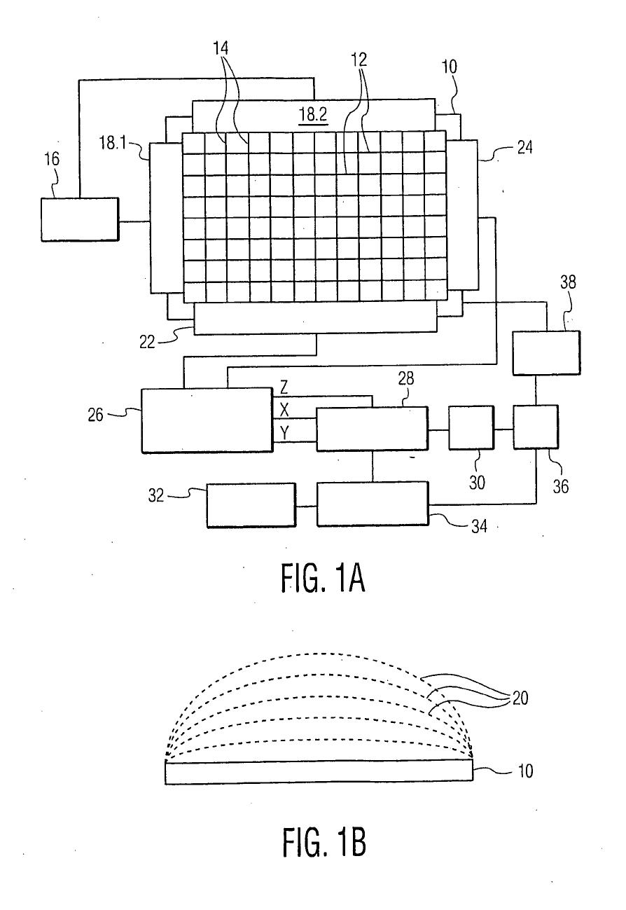

FIG. 1A is a block diagram of a display device having a capacitive sensor array incorporated therein;

FIG. 1B is a diagram showing the detection lines of the sensor array of FIG. 1A;

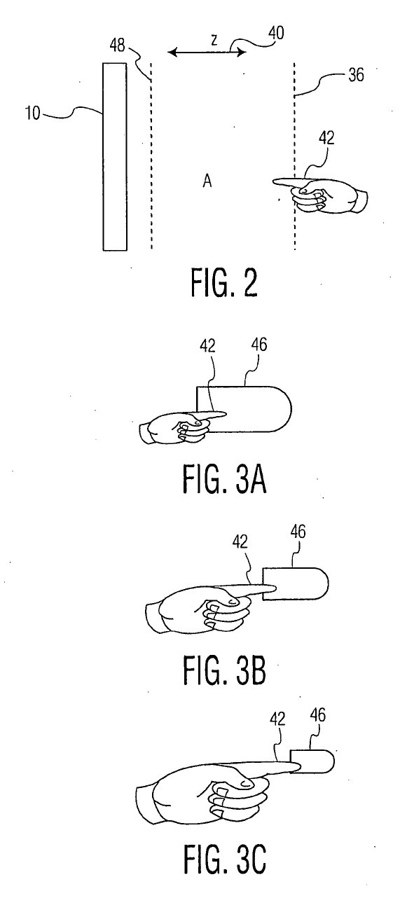

FIG. 2 is a diagram showing the detection zone extending from the surface of the display screen; and

FIGS. 3A-3C show virtual shadows of varying sizes formed on a display screen corresponding to a user's finger at varying distances from the display screen.

The subject invention makes use of a 3-D display, that is, a display that is capable of detecting the horizontal and vertical position of a pointer, stylus or a user's finger with respect to the surface of the display screen, as well as the distance of the pointer, stylus or user's finger from the surface of the display screen. There are various known types of 3-D displays using, for example, infrared sensing, capacitance sensing, etc. One type of a 3-D display is disclosed in U.S. Patent Application Publication No. US2002/0000977 A1, which is incorporated herein by reference.

As shown in FIG. 1A, a display screen 10 has superimposed thereon a grid of electrically conductive transparent conductors in which the horizontal conductors 12 are electrically isolated from the vertical conductors 14. A voltage source 16 connected to connection blocks 18.1 and 18.2 applies a voltage differential across the horizontal and vertical conductors 12 and 14. This arrangement develops a detection field 20 extending away from the surface of the display screen 10 as shown in FIG. 1B, with the horizontal and vertical conductors 12 and 14 acting as plates of a capacitor.

When, for example, a user's finger enters the detection field 20, the capacitance between the conductors 12 and 14 is affected and is detected by X-axis detector 22, connected to the vertical conductors 14 and the Y-axis detector 24, connected to the horizontal conductors 12. A detector signal processor 26 receives the output signals from the X and Y detectors 22 and 24 and generates X, Y coordinate signals and a Z distance signal. The X and Y coordinate signals and the Z distance signal are applied to a cursor and zoom controller 28 which then applies control signals to an On-Screen Display (OSD) controller 30.

In addition, as shown in FIG. 1A, a image signal source 32 supplies an image signal to a image signal processor 34, which also receives a zoom control signal from the cursor and zoom controller 28. A video switch 36 receives the output signals from the OSD controller 30 and the image signal processor 34 and supplies a composite output signal to a display controller 38 which then applies video signals to the display screen 10.

As shown in FIG. 2, the cursor and zoom controller 28 establishes a zone A extending in the Z direction (dual-headed arrow 40) from the surface of the display screen 10. The zone A denotes a zone in which, when the user's finger 42 passes a threshold distance 44, the user's finger 42 is detected and, in a first embodiment, the cursor and zoom controller 28 displays a virtual drop shadow 46 of the user's finger, as shown in FIG. 3A. The virtual drop shadow 46 has predetermined initial parameters including size, color, darkness and texture. By moving his/her finger 42 in the X and/or Y direction, the user can then move the virtual drop shadow 46 to the appropriate portion of the displayed image forming the center of the image for zooming. Then, as the user moves his/her finger 42 closer to the display screen 10, the virtual drop shadow 46 is, for example, reduced in size until maximum zooming is achieved and the virtual drop shadow 46 is substantially the same size as the user's finger 42. This is illustrated in FIGS. 3A-3C where the user's finger 42 is shown progressively larger as it approaches the display screen 10, while the virtual drop shadow 46 is shown correspondingly smaller. Alternatively, instead of, or in addition to, changing the size of the virtual drop shadow 46, the cursor and zoom controller 28 may change the color, the darkness or the texture of the virtual drop shadow 46.

In an alternate embodiment, as shown in FIG. 2, the cursor and zoom controller 28 establishes a second threshold distance 48 at a distance close to the display screen 10. When the user's finger 42 passes this threshold, the zooming is then terminated and the virtual drop shadow 46 is removed from the display screen 10.

Although this invention has been described with reference to particular embodiments, it will be appreciated that many variations will be resorted to without departing from the spirit and scope of this invention as set forth in the appended claims. The specification and drawings are accordingly to be regarded in an illustrative manner and are not intended to limit the scope of the appended claims.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) any of the disclosed elements may be comprised of hardware portions (e.g., including discrete and integrated electronic circuitry), software portions (e.g., computer programming), and any combination thereof;

f) hardware portions may be comprised of one or both of analog and digital portions;

g) any of the disclosed devices or portions thereof may be combined together or separated into further portions unless specifically stated otherwise; and

h) no specific sequence of acts is intended to be required unless specifically indicated.

1. A 3-D display device capable of selectively zooming an image being displayed on said display device, said 2-D display device comprising:
means (22, 24, 26) for detecting a distance (Z) that a finger (42) of a user is from a display screen 10 of the display device, said detecting means (22, 24, 26) generating a detection signal when said distance is within a first predetermined threshold distance (36);
means (22, 24, 26) for determining a position of said user's finger (42) with respect to said display screen (10);
means (28, 30, 36, 38) for displaying a virtual drop shadow (46) on said display screen (10) at said determined position in response to said detection signal, said virtual shadow (46) having predetermined initial parameters when said user's finger (42) is at said first predetermined threshold distance (36);
means (28, 34) for initiating zooming of said image in response to said detection signal, said zooming being centered on said determined position, and an amount of said zooming being inversely dependent on said detected distance (Z); and
means (28) for changing at least one of said predetermined initial parameters of the virtual drop shadow (46) with respect to said detected distance (Z).

2. The 3-D display device as claimed in claim 1, wherein said detecting means (22, 24, 26) stops generating said detection signal when said user's finger (42) passes a second predetermined threshold distance (48), said second predetermined threshold distance (48) being closer to said display screen (10) than said first predetermined threshold distance (36).

3. The 3-D display device as claimed in clam 1, wherein said predetermined initial parameters include size, color, darkness and texture.

4. The 3-D display device as claimed in claim 3, wherein said changing means (28) decreases the size of said virtual drop shadow with respect to said detected distance.

5. The 3-D display device as claimed in claim 3, wherein said changing means (28) varies the darkness of said virtual drop shadow with respect to said detected distance.

6. The 3-D display device as claimed in claim 3, wherein said changing means (28) changes the color of said virtual drop shadow with respect to said detected distance.

7. A method for selectively zooming an image being displayed on said display device, said 2-D display device comprising the steps of:
detecting ((22, 24, 26) a distance (Z) that a finger (42) of a user is from a display screen (10) of the display device, and generating a detection signal when said distance (Z) is within a first predetermined threshold distance (36);
determining (22, 24, 26) a position of said user's finger (42) with respect to said display screen (10);
displaying (28, 30, 36, 38) a virtual drop shadow (46) on said display screen (10) at said determined position in response to said detection signal, said virtual drop shadow (46) having predetermined initial parameters when said user's finger (42) is at said first predetermined threshold distance (36);
initiating zooming (28, 34) of said image in response to said detection signal, said zooming being centered on said determined position, and an amount of said zooming being inversely dependent on said detected distance (Z); and
changing (28) at least one of the predetermined initial parameters of the virtual drop shadow with respect to said detected distance.

8. The method as claimed in claim 7, wherein in said detecting step, the generation of said detection signal is stopped when said user's finger (42) passes a second predetermined threshold distance (48), said second predetermined threshold distance (48) being closer to said display screen (10) than said first predetermined threshold distance (36).

9. The method as claimed in claim 7, wherein said predetermined initial parameters include size, color, darkness and texture.

10. The method as claimed in claim 9, wherein said changing step decreases the size of said virtual drop shadow with respect to said detected distance.

11. The method as claimed in claim 9, wherein said changing step varies the darkness of said virtual drop shadow with respect to said detected distance.

12. The method as claimed in claim 9, wherein said changing step changes the color of said virtual drop shadow with respect to said detected distance.
